(19) United States
(12) Patent Application Publication
(10) Pub. No.: US 2010/0081466 A1
(43) Pub. Date: Apr. 1, 2010

(54) Wireless Communication System

(75) Inventor: Xiaodong Mao, Foster City, CA (US)

Correspondence Address: KATTEN MUCHIN ROSENMAN LLP, 575 MADISON AVENUE, NEW YORK, NY, 10022-2585, US

(73) Assignee: SONY COMPUTER ENTERTAINMENT INC.,, Foster City, CA (US)

(21) Appl. No.: 12/549,688

(22) Filed: Aug. 28, 2009

(30) Foreign Application Priority Data
Sep. 5, 2008 (GB) 0816293.5

(51) Int. Cl. H04B 7/00

(52) U.S. Cl. 455/500

(57) ABSTRACT

A wireless communication system operating within a predetermined frequency band comprises a wireless data receiving device; and two or more wireless data originating devices each having a respective unique identifier which is transmitted to the wireless data receiving device from time to time; in which: the wireless data originating devices are arranged to communicate with the wireless data receiving device on frequency channels selected from respective different subsets of the predetermined frequency band.

### BACKGROUND OF THE INVENTION

1. Field of the Invention

This invention relates to wireless communication systems.

2. Description of the Prior Art

Wireless communication is used in many different applications. An example, though non-limiting, application in the transmission of audio information will now be discussed.

As an example of a wireless communication system, so called wireless microphones are commonly used in live and broadcast entertainment. Analogue systems generally use frequency modulated radio transmission, with the selection of the carrier frequency defining which microphone communicates with which receiver. So-called hybrid digital microphones use digital signal processing with the aim of improving sound quality, but still use an analogue radio transmission channel.

Microphone systems using entirely digital transmission either use the carrier frequency to identify each microphone, or employ a coded spread spectrum frequency-hopping technique similar to that used in DECT telephones (Digital Enhanced Cordless Telephones) and Bluetooth® audio devices such as headsets (earphone and microphone combinations) for mobile telephones. In such a system, packets of data are carried by carrier frequencies in a sequence (e.g. a pseudo-random sequence) of carrier frequencies.

There are difficulties with both of these arrangements for electronically distinguishing one wireless microphone from another. Such difficulties might become apparent if microphones of this type were used in, for example, a karaoke game or the like, such as the SingStar® game marketed for use with the Sony® PlayStation 2® or PlayStation 3® entertainment devices.

In such applications, it is normally a requirement to use two or more microphones simultaneously (the SingStar® game currently uses two for inter-player competitions). So, it is essential not only that the two microphones can be distinguished, but that each microphone can be associated with the correct player or team.

But in the context of a mass-market game, a simple carrier-frequency based arrangement could lead to problems, if more than one microphone operating on the same frequency were introduced to the game at the same time or were being used in adjacent rooms. On the other hand, a coded spread spectrum technique would make it possible to distinguish the microphones but not necessarily to associate them correctly with the respective game players.

### SUMMARY OF THE INVENTION

An object of the present invention is to provide an improved wireless communication system.

This invention provides a wireless communication system operating within a predetermined frequency band, the system comprising:

a wireless data receiving device; and

two or more wireless data originating devices each having a respective unique identifier which is transmitted to the wireless data receiving device from time to time; in which:

the wireless data originating devices are arranged to communicate with the wireless data receiving device on frequency channels selected from respective different subsets of the predetermined frequency band.

The invention uses the innovative combination of a frequency based identification technique (allowing, in example embodiments, a definitive allocation of microphone to player in a karaoke game) and a code-based identification system (allowing, in example embodiments, multiple microphones in the same frequency band to be distinguished).

Various other respective aspects and features of the invention are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 schematically illustrates a wireless microphone system;

FIG. 2 schematically illustrates the operation of a wireless microphone;

FIG. 3 schematically illustrates a frequency-hopping process;

FIG. 4 schematically illustrates a data packet; and

FIG. 5 is a flow diagram schematically illustrating the interaction of a wireless microphone and a base unit.

### DESCRIPTION OF THE PREFERRED EMBODIMENTS

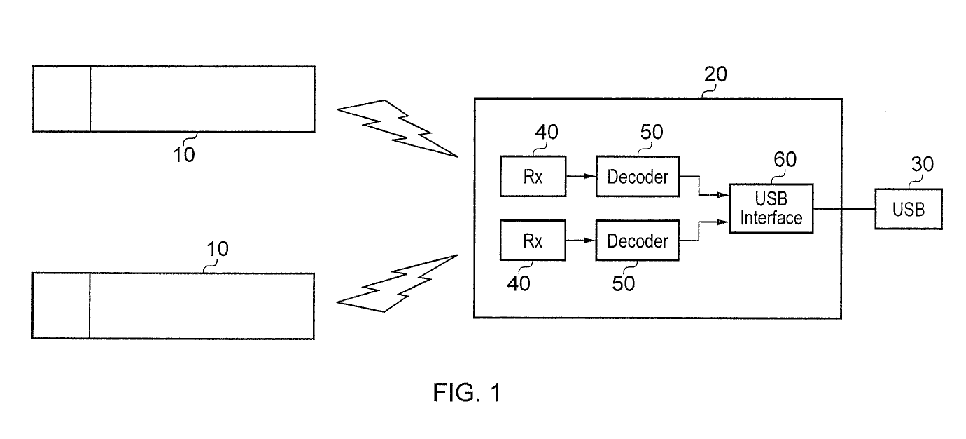

Referring now to FIG. 1, a digital wireless microphone system comprises two wireless microphones 10 and a wireless data receiver 20.

The wireless microphones 10 will be referred to as data originating devices, in that they detect sound waves and convert them to digital data which is transmitted to the data receiver 20. Similarly, the data receiver's main function is to receive such data. However, it is apparent that in a digital wireless system of this sort, there will generally be some data flow in the reverse direction, i.e. from receiver to microphone, for the purposes of initial handshaking, packet acknowledgement, error indication and the like. Accordingly, the use of these terms is for convenience, to indicate the primary function of the data originating device and the data receiver, and does not exclude the transmission of data in such a reverse direction.

The data receiver is arranged to mimic a wired USB interface which is currently supplied by Sony Computer Entertainment, Inc® with the SingStar karaoke game. In that wired interface, two wired microphones are arranged to plug into an adaptor or “dongle” which in turn plugs into a USB socket on the PlayStation machine hosting the game. The function of the wired microphones and dongle is to convert the analogue output of a pair of audio transducers into serial digital data which can be passed via the USB interface to the PlayStation machine. The data receiver 20 in FIG. 1 is arranged to output data to a USB connector 30 which exactly mimics the output of the existing wired dongle. In principle, it should be impossible for the PlayStation machine to detect whether a wired or wireless microphone system is in use.

Because the PlayStation machine is unaware of the wireless side of the system, it cannot use the presence or absence of a radio frequency signal as an indicator of whether or not a microphone has been activated. Instead, the PlayStation machine can sample the audio output on each channel, particularly during a period (such as the song-selection process of the SingStar game) when there is normally a lot of noise coming from the loudspeaker of the user's television. If no audio output is detected, the PlayStation machine prompts the user to switch on the microphone, or bring it within range, or change the batteries.

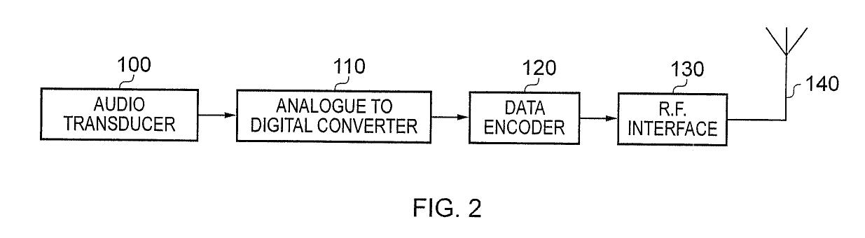

The internal operation of one of the microphones 10 is schematically illustrated in FIG. 2.

An audio transducer 100 (a data source device) detects sound waves and converts them to an analogue electrical signal. The analogue electrical signal is converted to a digital form by an analogue to digital converter 110. From this point (in the processing) onwards, the audio data remains in digital form. Note that both microphones operate in the same way and have substantially identical audio transducers and analogue to digital converters.

A data encoder 120 receives the raw audio data and encodes it for transmission. The encoding process employs known data compression in order to reduce the quantity of data that needs to be sent.

The encoded data is passed to a radio frequency (RF) interface 130, connected to an antenna 140. The RF interface packetises and modulates the data for transmission via a spread spectrum frequency-hopping system in a predetermined frequency band—in this example the so-called ISM band between 2.4 and 2.4835 Gigahertz. Each data packet carries multiple bytes of audio data and a 6 byte (48 bit) code which uniquely identifies that particular microphone. (In other arrangements, the identification code need be carried in just some of the packets from time to time, such as alternate packets or irregularly spaced packets). The packets and the frequency-hopping system will be described in more detail below.

The transmission power is a balance between range, robustness and battery life (noting that the wireless microphones are powered by batteries, not shown). A transmission power is selected so as to provide a maximum range of about 5 to 10 metres.

As discussed below, each microphone communicates with the data receiver using a respective set of radio frequencies.

Referring back to FIG. 1, the data receiver 20 comprises a pair of RF receivers 40 (or, more generally, one for each wireless microphone with which the data receiver can concurrently communicate). These follow a frequency-hopping pattern which is the same as that followed by the respective microphone's RF interface 130 in order to receive the packetised audio data. The receivers have respective antennas which are so-called meander antennas. In normal use, these are angled away from the horizontal so as to improve data reception.

The audio data is decoded and, if required, decompressed by a respective decoder 50. The purpose here is to generate digital audio data having the same format as that generated within the wired dongle discussed above.

Finally, the audio data output by the two decoders is passed to a USB interface to be formatted into a serial data stream for transmission to the PlayStation machine hosting the game, via the USB connector 30.

As mentioned above, the available wireless spectrum (in this example, 2.4 to 2.4835 GHz) is partitioned between the two (or different number of) wireless microphones capable of concurrently interacting with the data receiver, so that different (preferably, though not exclusively, non-overlapping) subsets of the available spectrum are allocated to each wireless microphone/RF receiver. The partitions are established at manufacture of the microphones and data receiver, when the microphones are selected to be in one of two (or other number of) classes of device. In simple terms, the classes correspond to different players of the karaoke game and are typically indicated by a coloured label (such as a ring) on the microphone body, along with correspondingly coloured game instructions and scoring on the game screen. Each class is allocated a respective predetermined subset of the available frequency range.

In the wired SingStar microphones, one microphone is labelled as red, and the other as blue. In the wireless version, it is therefore desirable (to allow interaction with the same SingStar games) that one wireless microphone should be “red” and one “blue”. The red and blue labels therefore represent the different classes, which in turn define the partitioned frequency bands available to each microphone.

In the present example, the division into classes is achieved at manufacture. There are advantages to this technique in terms of the microphones' identification data, as discussed below. However, it could be arranged that an individual microphone could be user-reprogrammable to allow it to be used in a different class.

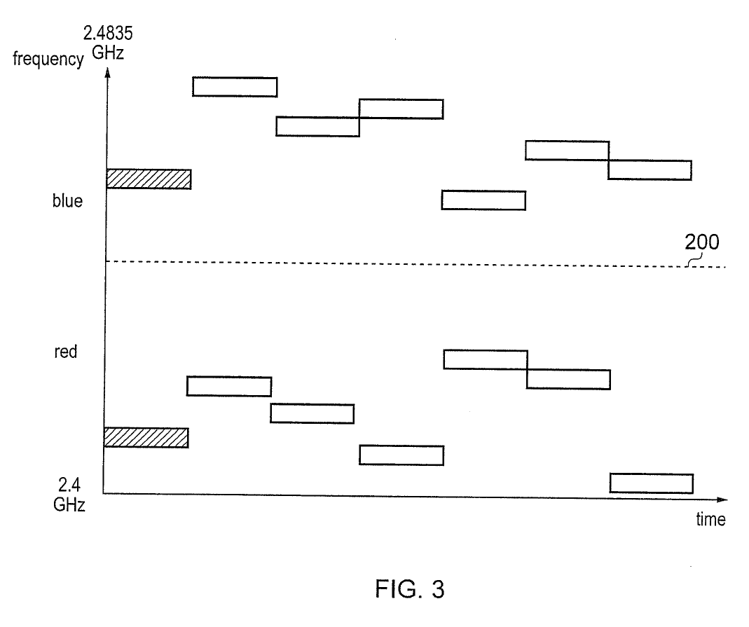

Within these partitioned frequency bands, a spread spectrum frequency-hopping arrangement is used. FIG. 3 schematically illustrates one way in which this can be done.

FIG. 3 shows the total available frequency band (e.g. 2.4 to 2.4835 GHz) on a vertical axis, with a horizontal dotted line 200 representing a partition between “blue” and “red” microphones.

Time is represented along a horizontal axis. Therefore, the transmission of packets of data (each of which takes a period of time and occupies a channel bandwidth) is schematically shown in this representation as a succession of rectangles.

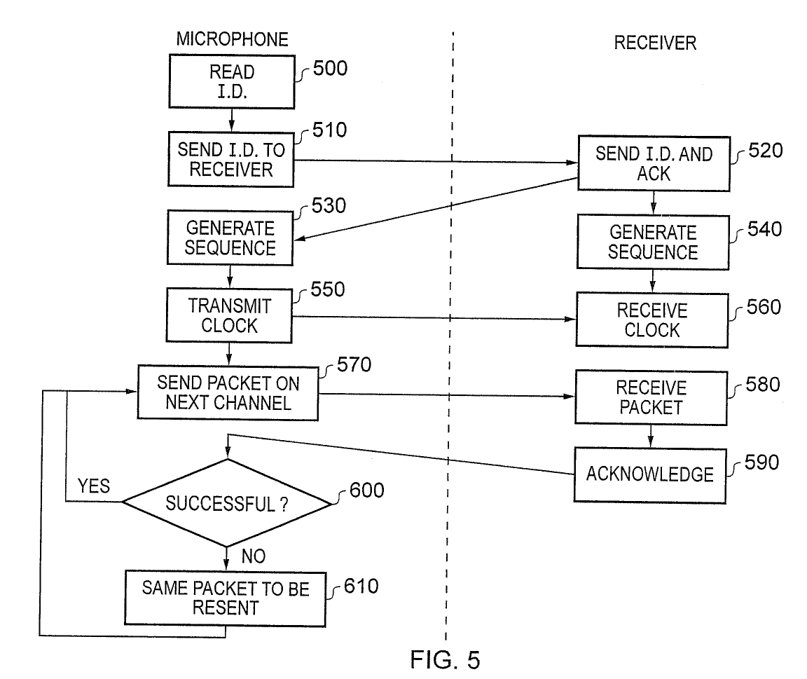

A first rectangle for each of the two microphones is shown in shaded form. This is to indicate that this packet represents an exchange of initial handshaking data in order to establish the connection or “pairing” between the microphone and the data receiver, and to set up the sequence (see FIG. 5 below) for the frequency-hopping to follow. The handshaking interaction takes place on a predetermined frequency within the available band for that microphone.

Some notes on the schematic nature of FIG. 3 will now be provided. The exchange of handshaking data may take more time or less time than the subsequent packet length; the representation in FIG. 3 is simply a schematic representation.

Similarly, it should be noted that the exchange of handshaking data may well take place when the microphone is first switched on, or first comes within wireless range of the data receiver. In practice this is likely to happen at different times for the two microphones. Finally, depending on whether the packet synchronisation is carried out by the microphones or by the data receiver, it may be that packets from one microphone are not in fact time-aligned (as they are shown in FIG. 3) with packets from the other microphone.

Once the handshaking process has been completed, data packets carrying audio data are transmitted from the microphones to the data receiver in accordance with the frequency-hopping pattern set up by the initial handshaking process. It can be seen in FIG. 3 that packets corresponding to the “blue” microphone are sent using frequency channels above the boundary represented by the line 200, whereas those for the “red” microphone are sent using frequency channels below that boundary.

It will be appreciated that if more than two microphones are arranged to interact concurrently with the data receiver, then the ISM band can be partitioned into a corresponding number of frequency partitions. For example, this could be done by equal division, as in the following example (all frequencies are in GHz):

| Number of | | | | |
|---|---|---|---|---|
| microphones | band 1 | band 2 | band 3 | band 4 |
| 2 | 2.4000-2.4418 | 2.4418-2.4835 | | |
| 4 | 2.4000-2.4209 | 2.4209-2.4418 | 2.4418- | 2.4626-2.4835 |
| etc | | | 2.4626 | |

It is easier if the partitioned bands are non-overlapping (i.e. whatever the allocation scheme, any particular frequency is available only for a respective one of the microphones)

Alternatively, the total frequency band could be partitioned by (for example) first dividing it into channels each capable of carrying the data transmission rate applicable to the normal transmission of a packet of data, and then allocating these channels amongst the required number of microphones. So, for example, the channels could be allocated using a simple interleaving algorithm as blue, red, blue, red . . . . In the case of a larger number of microphones this could be blue, red, green, yellow, blue red, green, yellow . . . . Or a more complex interleaving arrangement could be used. In general, an interleaved partitioning can add complexity but has the possible advantage that localised narrowband interference is more likely to be spread across the microphones rather than just affecting one of them.

In a further alternative, a simple partition of the type shown in FIG. 3 could be used if just two microphones are to be used, but if a further microphone is added one of the two half-bands shown in FIG. 3 could be split by interleaving.

FIG. 3 schematically shows two substantially independent frequency-hopping patterns for the two microphones. In an alternative embodiment, one pattern could be the inverse of the other. That is to say, if (for example) the available channels for each microphone (i.e. in their respective half-band) were numbered in each case in frequency-ascending order from (say) 1 to 100, the frequency-hopping pattern could proceed as follows:

| Packet | Red Channel | Blue Channel |
|---|---|---|
| 1 | 3 | 97 |
| 2 | 7 | 93 |
| 3 | 67 | 33 |
| 4 | 28 | 72 |
| 5 | 91 | 9 |
| 6 | 13 | 87 |
| 7 | 46 | 54 |
| 8 | 34 | 66 |
| 9 | 78 | 22 |
| 10 | 97 | 3 |
| 11 | 53 | 47 |
| etc | | |

In other words, the frequency separation between the bottom of the red band and the current channel is the same as the frequency separation between the top of the blue band and the current channel.

In another possibility, using the same channel numbering scheme, the channel allocations could simply track one another:

| Packet | Red Channel | Blue Channel |
|---|---|---|
| 1 | 3 | 3 |
| 2 | 7 | 7 |
| 3 | 67 | 67 |
| 4 | 28 | 28 |
| 5 | 91 | 91 |
| 6 | 13 | 13 |
| 7 | 46 | 46 |
| 8 | 34 | 34 |
| 9 | 78 | 78 |
| 10 | 97 | 97 |
| 11 | 53 | 53 |
| etc | | |

Both of these arrangements of inter-related sequences can have advantages in terms of unwanted intermodulation products at the receiver (albeit different intermodulation products in the two cases) which will always be at predictable (predetermined) frequencies.

The derivation of the frequency-hopping pattern can be via a pseudo-random sequence seeded or otherwise influenced by a unique identification associated with the microphone and by a timing signal exchanged between the microphone and the data receiver at the initial handshake. In some embodiments (see below) the unique identifications associated with a pair of microphones are the binary complements of one another; such an arrangement could be arranged so as to lead to the generation of one of the patterns set out in the tables above.

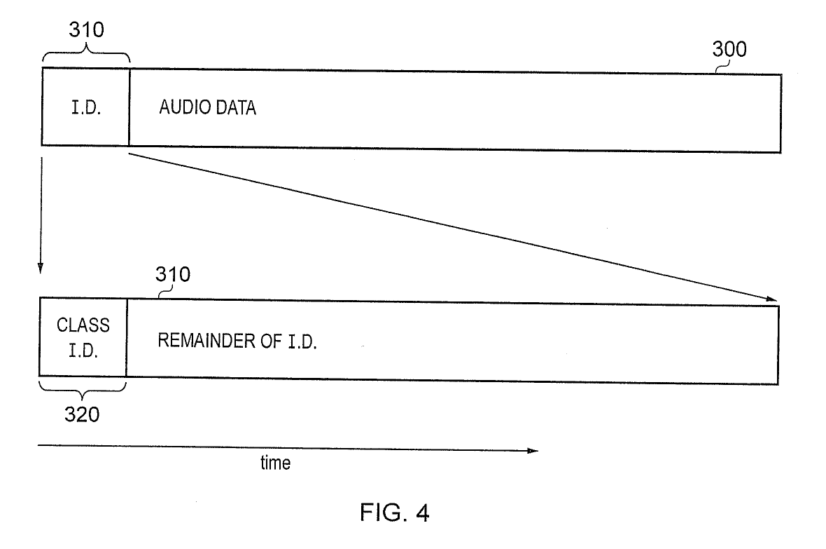

FIG. 4 schematically illustrates a data packet 300 sent by one of the microphones to the data receiver. In FIG. 4, time is represented in a horizontal left-to-right direction.

The packet 300 comprises, in time order, unique identification data 310 associated with that particular microphone, followed by a payload of audio data. Further data such as headers, footers and error detection/correction data may be included using known techniques; FIG. 4 is just intended to show the technically significant parts of the data that are transmitted.

The identification data is transmitted first, to allow a rapid detection of which microphone has transmitted the packet, and therefore a correct routing to the appropriate audio channel at the data receiver. Indeed, even if header data is used, it is preferred that the identification data is sent before such packet header data.

The lower section of FIG. 4 shows the identification data 310 in more detail. A first-transmitted portion 320 of the identification data represents the class (e.g. red or blue) of the microphone. The remainder of the 48 bits of identification data provides a unique identification of that particular unit.

It will be appreciated that as used here, the term “unique” simply indicates uniqueness (or quasi-uniqueness) with respect to other instances of this type of microphone.

By transmitting the class identifier first, the correct handling of the packet can be established at the earliest possible time.

Clearly, if the system is set up so as only to handle two microphones, the class identifier 320 need be only one bit. In the case of up to four microphones, it would require a minimum of two bits, and so on.

The identification data is established at manufacture of the microphones. As the microphones are normally sold in a set (e.g. one red, one blue microphone, or one of each class in the case of a greater number of classes), it is advantageous that within such a set, the identification data are mutually orthogonal.

A simple way in which this can be achieved in the case of a pair of microphones is to arrange for the entire 48 bits of identification data for one microphone to be the binary complement of the identification data for the other microphone (so that a binary 1 in the identification data for one microphone becomes a binary 0 in the corresponding position in the other microphone's identification data, and vice versa).

This arrangement can make the identification system used to identify the microphones to the data receiver particularly robust against interference or lost data.

In the case of a set of more than two microphones, known mathematical techniques can be used to arrive at a group of mutually orthogonal identification codes.

Finally, FIG. 5 is a flow diagram schematically illustrating the interaction of a wireless microphone and a base unit. Operations carried out by the wireless microphone are shown to the left of a central vertical dashed line, and those carried out by the data receiver are shown to the right of the vertical line.

The initial handshaking operations mentioned above relate to steps 500-560. The subsequent transmission of packets relates to steps 570-610.

At a step 500, the microphone reads its stored unique identification data, and at a step 510 this data is transmitted to the data receiver using the predetermined handshaking radio channel. The data receiver receives the identification data and acknowledges it at a step 520.

In response to the receipt of the identification data the data receiver generates a pseudo-random frequency-hopping sequence at a step 540. The microphone does the same thing at a step 530, in response to receipt of the data receiver's acknowledgement.

At a step 550, the microphone transmits a clock signal to the data receiver, which receives it at a step 560. The previously generated sequence and the newly received clock signal are sufficient to define the exact timing of the frequency-hopping pattern to be followed by both devices.

Note that the arrangement illustrated in FIG. 5 uses the microphone as a “master” device to control the timing of the frequency-hopping. Of course, it could be that the data receiver acts in this way, and so the transmission of the clock signal at the steps 550, 560 could in fact be from the data receiver to the microphone. Such an alternative would have the advantage of providing the same timing to both (or all) microphones in use.

The handshaking exchange has now been completed, and transmission of audio data packets can commence.

At a step 570, the microphone sends a packet to the data receiver, which receives it at a step 580 and acknowledges it at a step 590. Whether the packet has been successfully sent is detected by the microphone at a step 600, on the basis of the acknowledgement received from the data receiver. If the packet has been successfully sent, then control returns to the step 570 and the next packet is sent, and so on. If however the current packet has not been successfully sent, then at a step 610 the microphone causes the same packet to be resent, albeit on the next channel in the frequency-hopping sequence.

The ability to resend packets depends of course on the ratio of the data channel capacity to the amount of data to be sent. If there is no spare capacity, then the step 610 would simply involve discarding the failed packet, and the receiver would have to use any available error correction or concealment techniques to mask the failed packet. However, if there is some spare capacity then a packet can be resent, though possibly limited to a predetermined number (e.g. 2) of retries.

These techniques can be extended to single channel systems (i.e. those not using spread spectrum frequency-hopping techniques, but rather allocating a single channel to each wireless device). Here, the available RF spectrum can be partitioned as described above, and techniques such as the allocation of complementary RF channels to a pair of microphones can be used. Also, the techniques of sending a class identifier first in a data packet can be applied. It will also be appreciated that groups of multiple packets can be sent on a single channel before the channel is changed under the frequency-hopping arrangement. That is to say, the rate of frequency-hopping can be lower than (e.g. a sub-multiple of) the rate of sending packets.

Although illustrative embodiments of the invention have been described in detail herein with respect to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A wireless communication system operating within a predetermined frequency band, said system comprising:
a wireless data receiving device; and
two or more wireless data originating devices each having a respective unique identifier which is transmitted to said wireless data receiving device from time to time;
in which:
said wireless data originating devices are arranged to communicate with said wireless data receiving device on frequency channels selected from respective different subsets of said predetermined frequency band.

2. A system according to claim 1, in which said wireless data originating devices comprise substantially identical data source devices.

3. A system according to claim 2, in which said data source devices are audio transducers.

4. A system according to claim 1, in which said subsets of said predetermined frequency band are non-overlapping.

5. A system according to claim 1, in which each of said wireless data originating devices is a member of one of two or more classes of devices, each class having an associated respective different subset of said predetermined frequency band.

6. A system according to claim 5, in which said class of a wireless data originating device is predetermined at manufacture.

7. A system according to claim 5, in which each wireless data originating device's unique identifier includes a class identifier indicating said class of that wireless data originating device.

8. A system according to claim 7, in which, when a wireless data originating device transmits that device's unique identifier to said wireless data receiver, said class identifier transmitted as a first portion of said transmitted unique identifier.

9. A system according to claim 5, in which said subsets of said predetermined frequency band available for use by a wireless data originating device are predetermined according to said class of that device.

10. A system according to claim 1, in which communication between said wireless data originating devices and said wireless data receiver uses a frequency-hopping arrangement in which a sequence of different carrier frequencies is used to transmit successive packets of data.

11. A system according to claim 10, in which said sequence used by a wireless data originating device is dependent, at least in part, on said unique identifier associated with that wireless data originating device.

12. A system according to claim 10, in which said sequences used by said two or more wireless data originating devices are inter-related so as to generate intermodulation products at predetermined frequencies.

13. A system according to claim 1, in which:
said unique identifiers associated with said wireless data originating devices are mutually orthogonal.

14. A system according to claim 13, in which:
said system comprises two wireless data originating devices; and
said unique identifiers associated with said two wireless data originating devices are binary complements of one another.

15. A system according to claim 1, in which said wireless data receiver comprises one radio frequency communication device for each wireless data originating device with which said wireless receiver is capable of simultaneous communication;
each radio frequency communication device being arranged to communicate data according to a respective one of said subsets of said predetermined frequency band.

16. A system according to claim 1, in which said predetermined frequency band is a frequency band between 2.4 and 2.4835 Gigahertz.

17. A set of two or more wireless data originating devices each having a respective unique identifier which is transmitted to a wireless data receiving device from time to time, said unique identifiers being mutually orthogonal.

18. A set according to claim 17, in which:
said set comprises two wireless data originating devices; and
said unique identifiers are binary complements of one another.

19. A set according to claim 17, in which said wireless data originating devices are arranged to communicate with said wireless data receiving device on frequencies selected from respective subsets of a predetermined frequency band.
